(19) United States
(12) Patent Application Publication
(10) Pub. No.: US 2016/0006362 A1
(43) Pub. Date: Jan. 7, 2016

(54) Non-isolated AC to DC power device having gain stabilization

(71) Applicant: Bourns, Inc., Riverside, CA (US)

(72) Inventor: Andrew J. Morrish, Saratoga, CA (US)

(21) Appl. No.: 14/857,702

(22) Filed: Sep. 17, 2015

Related U.S. Application Data
(63) Continuation-in-part of application No. 14/341,376, filed on Jul. 25, 2014.
(60) Provisional application No. 61/858,489, filed on Jul. 25, 2013.

(51) Int. Cl. H02M 7/06

(52) U.S. Cl. CPC H02M 7/06

(57) ABSTRACT

An AC to DC power supply is provided based on feed back control of an analog current blocking (ACB) device. The ACB element receives rectified high voltage AC. The output of the ACB element is provided to an integrating circuit that provides an output DC voltage. The output DC voltage depends on the average current passed by the ACB element. The average current passed by the ACB element depends on the current limit of the ACB element, which is under feed back control. Gain stabilization can be employed to accommodate a wide range of input voltages (e.g., for worldwide use).

### CROSS REFERENCE TO RELATED APPLICATIONS

This application is a continuation in part of U.S. Ser. No. 14/341,376, filed Jul. 25, 2014, and hereby incorporated by reference in its entirety.

Application Ser. No. 14/341,376 claims the benefit of U.S. provisional patent application 61/858,489, filed on Jul. 25, 2013, and hereby incorporated by reference in its entirety.

### FIELD OF THE INVENTION

This invention relates to power supply circuits for providing relatively low voltage direct current (DC) from relatively high voltage alternating current (AC).

### BACKGROUND

Many small appliances have a touchpad user interface, driven by a small low power microprocessor, featuring LED and LCD readouts, and controlling electronic functions such as motors, heaters etc. through either a Triac control or relays. Common examples include toaster ovens, coffee makers, and blenders, but there are many other such devices, both consumer and industrial.

These user interface and control circuits, which often control high power functions like a toaster grill heater element, all use very little power. They are rarely switched completely off, but instead sit in an idle state, where the microcontroller waits to detect a command from the user.

In most instances, these internal electronic control circuits are not electrically isolated from the AC mains, but rely upon physical isolation of the user interface. As configured, there is no reason for the electronics to be truly isolated, as there is no direct access, even though they run off low 3.3V or 5V supplies for example.

Similarly, another non-isolated power application is for low powered LED lighting. Nightlights use a small power supply to drive the sensor and one or more low power LEDs. Higher power emergency lighting may utilize a battery that is “trickle” charged to maintain its charge during the times AC is available, but may use the battery power to provide bright lighting when the AC is off for short periods, such as during a power outage.

These are all examples of electronic devices that consume small amounts of low voltage power, often in the region of less than 0.5 W in the case of the user interfaces, and less than around 150 mW per LED, in the case of illumination devices. Providing power from the high voltage AC to these devices has in the past used four main types of power supply—resistive droppers, capacitive droppers, linear transformer circuits, and switched mode power supplies.

The resistive dropper circuit is very simple and provides a low level of DC current. An exemplary resistive dropper circuit is shown on FIG. 1. Here input AC has its voltage lowered by a voltage divider including resistance Rd. The resulting low voltage AC is rectified by a bridge circuit 102, and the rectified output is smoothed by the combination of reservoir capacitor Cres and regulator diode Dreg to provide low voltage DC output voltage Vout. This circuit is extremely inefficient, requires a large power resistor Rd, and a requires a shunt regulation stage (Dreg) to absorb excess current

The capacitive dropper circuit, e.g. as shown on FIG. 2, replaces the power resistor Rd with a large capacitor Cd to supply current from the AC. Because the capacitor Cd is a reactive device, no power is dissipated in the capacitor, and so the capacitive dropper is more efficient than the resistive dropper. However, the current supply is unregulated, so it still requires a shunt regulation stage (Dreg) to absorb excess current. Therefore this circuit always consumes the maximum power required by the load, making it very inefficient when lower power than peak is consumed by the load, and when AC voltages higher than the specified minimum input AC voltage are used.

By using a linear transformer T1 as shown on FIG. 3, the AC voltage can be reduced to a low level, and is then rectified (by the low voltage bridge circuit of diodes D1, D2, D3, and D4) and smoothed. The output voltage is then regulated by regulator 302 to eliminate variation due to load and AC voltage variation. This circuit is simple, and only consumes the power used by the load (i.e., there is no need to shunt excess current). However, linear transformers dissipate power even under no load due to losses in the transformer core. Furthermore, the transformer is also a relatively large and costly component.

High frequency switching power supplies can be quite efficient, but are expensive to implement, are complex, and typically require considerable skill to achieve correct operation, and meet radio frequency interference requirements. FIG. 4 shows an exemplary arrangement for use of a switching mode power supply (SMPS) 402. Here 404 is a feed back network to provide the control input for SMPS 402. Components D1, C1, D2, C2 and L1 show typical input and output circuits for the SMPS. The basis of operation of a SMPS is to continually switch at a high frequency, storing small amounts of energy in an inductor, and transferring this energy to the load. Output voltage is varied by controlling the duty cycle of the switching, thus modulating the energy stored in the inductor (i.e., the ratio of on-time to off-time).

Although these methods each provide means of deriving a low voltage supply from the high voltage AC mains supply, each has significant disadvantages such as inefficiency, large footprint, costly components, and/or difficulty of implementation. Accordingly, it would be an advance in the art to provide an improved power supply approach.

### SUMMARY

The present approach provides a basically different concept for an AC to DC power supply. In this work, input AC voltage is first rectified. Either full wave or half wave rectification may be used. The rectified AC voltage is then provided to a series connected analog current blocking (ACB) element. After the series connected ACB element, a shunt capacitance can be provided as a charge reservoir (i.e., an integrating circuit) for the output DC voltage or current. The series connected ACB element has at least the following modes of operation: a low resistance (LR) mode and a high resistance (HR) mode, where the ACB element automatically transitions toward the HR mode when the current through the ACB element reaches a limit current Iₗᵢₘᵢₜ. It is advantageous to also incorporate a negative differential resistance (NDR) region between these two mode of operation, instead of a fast acting switch, approximating to an instantaneous transition between the LR and HR modes. The ACB element also automatically transitions toward the LR mode when the voltage across the ACB element goes below a reset voltage Vᵣₑₛₑₜ. The limit current Iₗᵢₘᵢₜ can be altered by a control signal applied to the ACB element and is under feed back control as described below. Such control of Iₗᵢₘᵢₜ also leads to a corresponding variation in Vᵣₑₛₑₜ.

Such an ACB element can be provided by modifying a transient blocking unit (which automatically switches to a high resistance state when its predetermined current limit is reached, and which automatically resets for sufficiently low voltages) to have an electrically adjustable current limit. Transient blocking units are known in the art for providing transient and surge protection for electrical loads. This approach for providing the ACB element gives the preferred characteristics that current flow is negligible in the HR mode, and series resistance is negligible in the LR mode.

In operation, the net effect of the ACB element is to pass part of the rectified waveform to the output capacitor for integration, where the controllable Iₗᵢₘᵢₜ determines how much of the rectified waveform is passed through to the output capacitor, thereby determining the charging current, and hence the output voltage. Thus, the output can be set to a desired level by feed back control using an error signal to set I_{Limit}. An important aspect of this approach is that the parts of the rectified waveform that are selected by the ACB element are the low-voltage parts of the waveform, thereby decreasing power consumption in the AC to DC converter.

Significant advantages are provided by the present approach:

1) This approach inherently provides a current limiting capability. For example, if the output of such a power supply is shorted, the resulting flow of current will still be limited by the ACB element, and destruction of the power supply due to this fault can readily be avoided. In sharp contrast, the simpler power supply concept where a switch is operated under feed back control using the output voltage is vulnerable to destruction by an output short. In such a circuit, the short will cause the output voltage to be too low, and the feed back control will respond by opening the switch up continuously. Excessive and destructive current flow is likely to result from this.

2) In embodiments having an NDR mode between the LR mode and the HR mode, the introduction of a specified negative resistance in this transition region can advantageously reduce voltage spikes when the ACB transitions from one mode to another mode. Such voltage spikes are created by the combination of stray inductance and fast rates of change of current, due to the relationship V=L dI/dt.

3) Gain stabilization can be employed to accommodate a wide range of input voltages (e.g., for worldwide use).

### BRIEF DESCRIPTION OF THE DRAWINGS

FIG. 1 shows a prior art power supply approach (resistive dropper).

FIG. 2 shows a prior art power supply approach (capacitive dropper).

FIG. 3 shows a prior art power supply approach (transformer+regulator).

FIG. 4 shows a prior art power supply approach (switching mode power supply).

FIG. 5 shows a block diagram of a power supply according to an embodiment of the invention.

FIG. 6 shows an exemplary I—V relation of an analog current blocking (ACB) device.

FIG. 7 shows how the limit current of an ACB element can be altered by changing a control input.

FIG. 8 shows operation of a power supply according to an embodiment of the invention.

FIG. 9 shows how changing an ACB current limit can change the average current flowing through the ACB element.

FIG. 10 shows a first exemplary circuit relating to embodiments of the invention.

FIG. 11 shows a second exemplary circuit relating to embodiments of the invention.

FIG. 12 shows a third exemplary circuit relating to embodiments of the invention.

FIG. 13 shows a fourth exemplary circuit relating to embodiments of the invention.

FIG. 14 shows a fifth exemplary circuit relating to embodiments of the invention.

FIG. 15 shows a sixth exemplary circuit relating to embodiments of the invention.

FIG. 16 shows an exemplary circuit to explain the utility of gain stabilization.

FIG. 17 shows operation of the example of FIG. 16.

FIG. 18 shows operation of the example of FIG. 16 at two different input voltages.

FIG. 19 shows gain vs. average current for the example of FIG. 16 at two different input voltages.

FIG. 20 shows gain vs. AC voltage at maximum load current for the example of FIG. 16.

FIG. 21 shows an exemplary gain-stabilized power supply circuit.

FIG. 22 shows operation of the example of FIG. 21 at two different input voltages.

FIG. 23 shows gain vs. AC voltage at maximum load current for the example of FIG. 21.

FIG. 24 shows shows operation of another exemplary gain-stabilized power supply circuit.

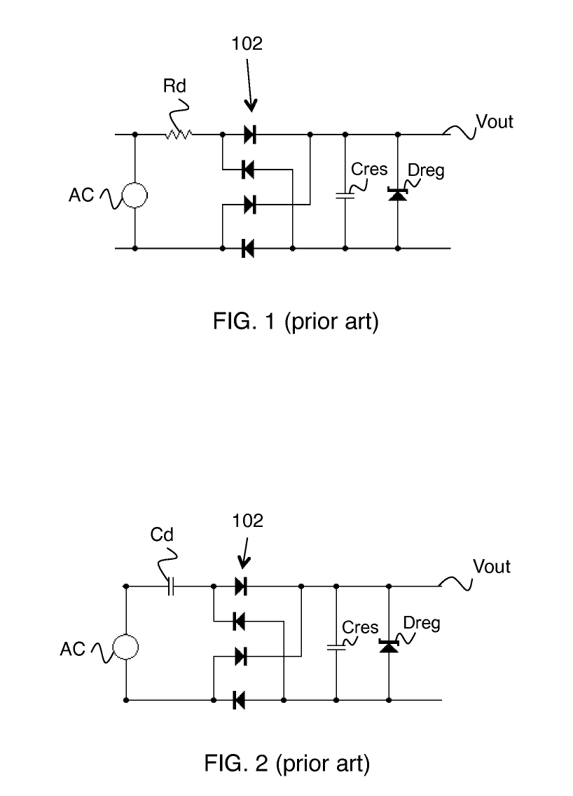

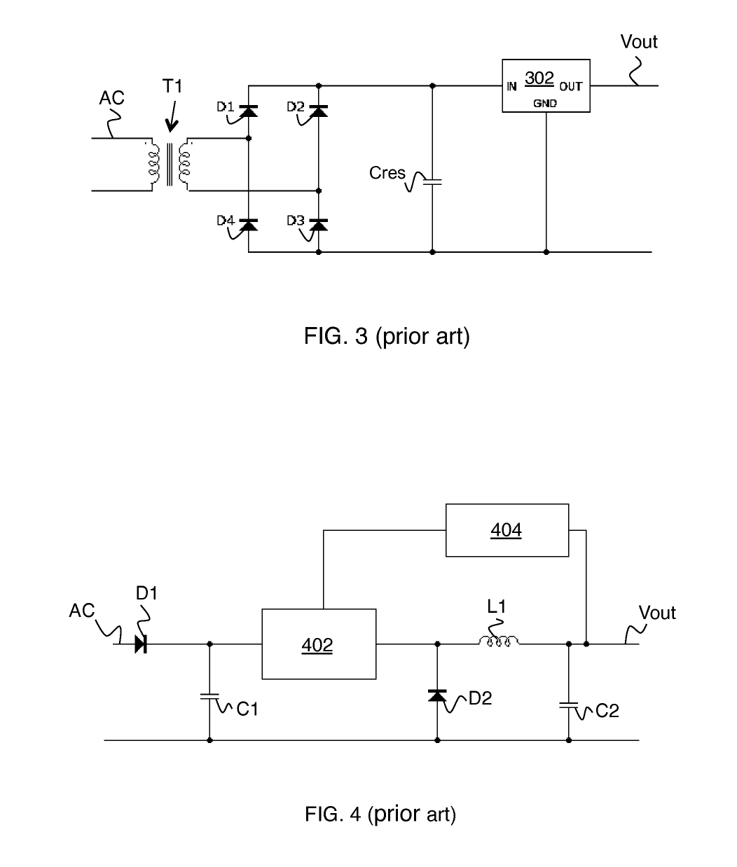

### DETAILED DESCRIPTION

### A) Power Supply

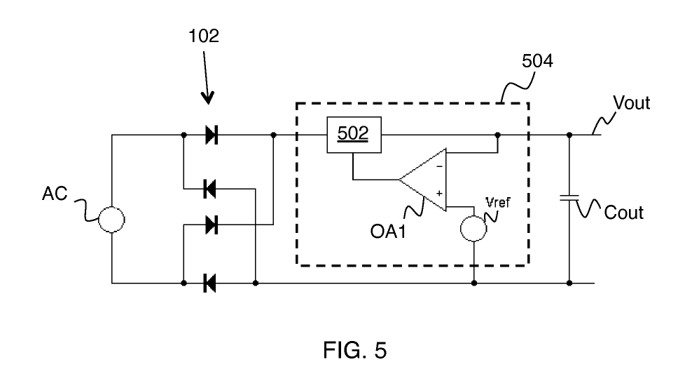

A new power supply concept is provided that provides a simple and efficient solution as an alternative to the existing methods described above. FIG. 5 shows the basic circuit topology. AC voltage is rectified by rectifier circuit 102 and the rectified AC is then applied directly to analog current blocking (ACB) device 502 that has a variable current limiting operation controlled by a signal derived from an error amplifier OA1, which compares the output to a known reference Vref. Smoothing of the output voltage Vout is provided by an integrating circuit connected to the output of the ACB element. In this example, the integrating circuit is capacitor Cout.

In essence, the ACB element operates as an active dropper circuit, acting like a low value resistor while the voltage across it is low, then transitioning to a high resistance state when the current through it exceeds a certain limit, which is set by the error amplifier. The error amplifier monitors the output voltage, and modulates the current limit value in response to load demand and AC line voltage. In this example, the control signal is an output of a differential amplifier (i.e., OA1) having as inputs a reference input (i.e., Vref) and the output of the integrating circuit (i.e., Vout).

In this way, ACB circuit 504 connected between the rectified AC and the load has a resistance characterized by having two or three distinct regions of operation:

1) a region of low resistance when the current through the device is below a threshold level corresponding to the current trigger threshold, (“Iₗᵢₘᵢₜ”), where Iₗᵢₘᵢₜ is controlled by a feed back signal. The resistance of the LR mode is preferably less than about 50Ω, and is more preferably less than about 5Ω.
2) optionally, a region of increasing resistance, whereby current initially limits at the trigger level, then reduces with increasing voltage across the device, giving rise to a current limiting and negative resistance characteristic. Preferably the NDR mode of the ACB element has an I/V slope of −1/R_{NEG}, where R_{NEG} is between about 0.2/Iₗᵢₘᵢₜₘₐₓ ohm and about 20/Iₗᵢₘᵢₜₘₐₓ ohm, where Iₗᵢₘᵢₜₘₐₓ is the maximum current limit of the apparatus.
3) a region of high resistance when the voltage is above a preset level (“Vᵣₑₛₑₜ”). The resistance of the HR mode is preferably greater than about 100 kΩ, and is more preferably greater than about 1 MΩ.

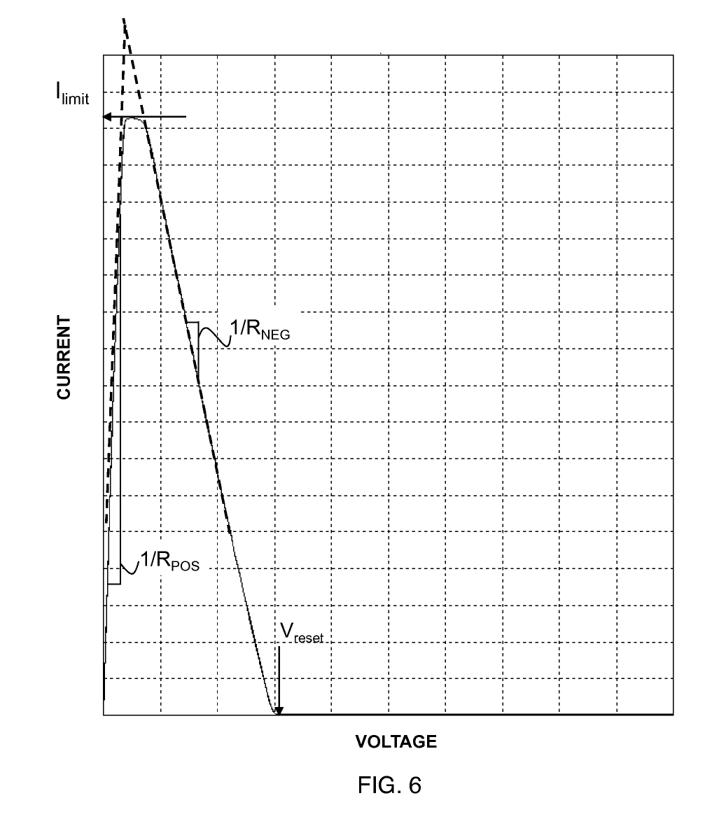

An exemplary I-V characteristic of the ACB element is shown on FIG. 6. A broad region of negative resistance is illustrated, but in practice, the extent of this region can be adjusted to suit the requirements of the particular application. In some cases, it has been found to be advantageous to utilize a wider region of negative resistivity, as this effectively slows the rate of current change with increasing voltage, which can otherwise result in excessively high transient voltages being developed across a parasitic inductance (as may be present in normal wiring), due to the relationship between induced voltage and rate of current change given by V=LdI/dt.

When a simple switch is used, dI/dt becomes extremely high, and hence the voltage V induced across the switch can also be very large, and may easily exceed the voltage rating of a typical semiconductor switching device (e.g. a MOSFET), causing avalanche breakdown. The energy stored in the stray inductance, L, at the peak current I is given by E=1/2 LI². This energy can easily exceed the maximum avalanche energy rating of the semiconductor switch, causing degradation of reliability, and failure. The use of a controlled negative resistance transition region allows the rate of current decrease to be controlled in such a way that the peak voltage is dramatically reduced, and safe operation of the circuit is ensured.

The NDR mode of the ACB element will have an I/V slope of-1/R_{NEG}, where R_{NEG} is approximately given by Vᵣₑₛₑₜₘₐₓ/Iₗᵢₘᵢₜₘₐₓ, and where Iₗᵢₘᵢₜₘₐₓ is the maximum current limit of the apparatus in amps, and Vᵣₑₛₑₜₘₐₓ is the reset voltage at Iₗᵢₘᵢₜₘₐₓ in volts. Note that the limit current Iₗᵢₘᵢₜ can be modulated, so Iₗᵢₘᵢₜₘₐₓ is its maximum value for a given circuit. From these considerations, it is preferred to set Vᵣₑₛₑₜₘₐₓ in the range of between 5V and 40V. At the lower end of the range, transition losses will be minimized but higher induced voltages may result. At the upper end of the range, lower voltages will be generated, but transition losses will be higher. A compromise value can be determined by consideration of the most important factors in the final application.

The advantage of a broader region of negative resistance is offset by additional power dissipation in operation. However, this is not usually a problem in the intended lower power applications. The exact value and width of the negative resistance region therefore becomes a design consideration depending upon the actual intended appliance application.

The current limit threshold is controlled by an error amplifier, which compares the output voltage to a set reference. The error amplifier can thereby continuously modulate the current limit in an analog closed loop regulated fashion, and precisely control the amount of power transferred to the output, thus closely controlling the output voltage. In this manner, a regulated output voltage can be provided.

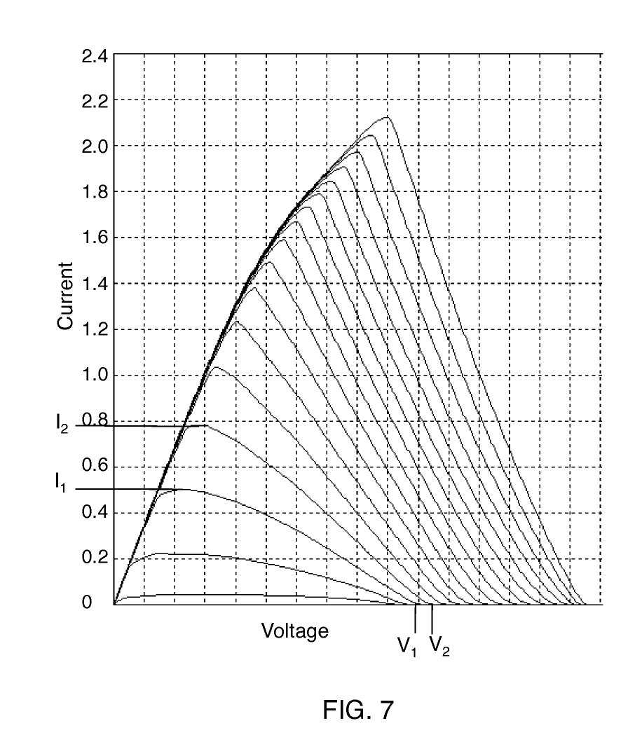

FIG. 7 shows an example of operation of an ACB element showing the capability to set different values for Vᵣₑₛₑₜ and Iₗᵢₘᵢₜ. The curves on FIG. 7 are simulated I-V curves of the ACB element for various values of the control signal. It is apparent that altering the control signal provided to the ACB causes both Iₗᵢₘᵢₜ (e.g., I₁, I₂, etc.) and Vᵣₑₛₑₜ (e.g., V₁, V₂, etc.) to change.

A reservoir capacitor Cres acts to remove the high frequency content of the ACB output current waveform, providing a smoothed voltage at the output, as is typical for most power supplies. Any integrating circuit can be employed for this function.

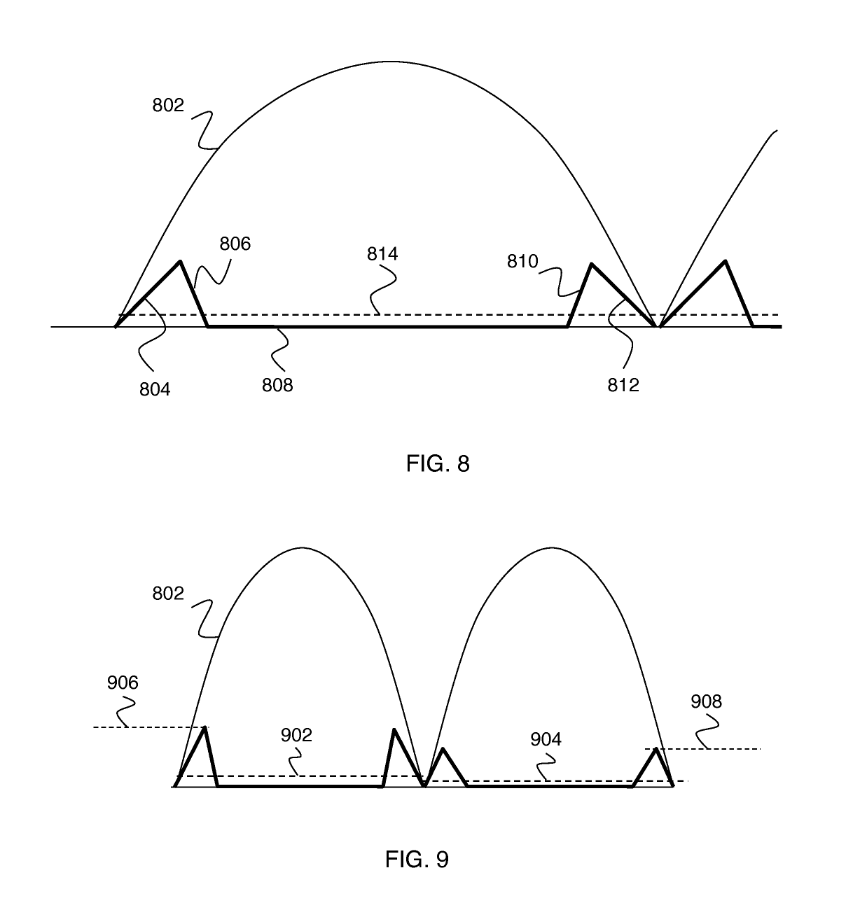

The operation of the circuit is shown on FIG. 8. When the rectified AC voltage 802 is applied, and voltage initially begins to rise, the ACB element provides a low value resistance. Current flows into the reservoir capacitance charging it towards the required level. The current rises in approximately a linear fashion, as shown by part 804 of the ACB output current trace (heavy black line on FIG. 8).

When the current reaches Iₗᵢₘᵢₜ, where Iₗᵢₘᵢₜ is controlled by the reference error amplifier, the ACB element current limits, and the resistance rapidly increases with rising input AC voltage, reducing the current to a low level, thereby creating the NDR region. The corresponding part of the ACB output current waveform is 806 on FIG. 8. As the voltage across the device reaches and exceeds the reset voltage, the ACB element resistance reaches a maximum, and the resistance stabilizes at this very high level. The corresponding part of the ACB output current waveform is 808 on FIG. 8.

Charge is stored by the reservoir capacitor, and gradually depleted by the load over the half rectified AC cycle. Because the resistance was low when the capacitor was charged, very little power was dissipated by the device connecting to the rectified AC. As the AC cycle continues, the rectified voltage drops back to a level below the reset voltage. The cycle reverses, and the resistance now begins to decrease, and current begins to flow again, recharging the reservoir capacitor. The corresponding part of the ACB output current waveform is 810 on FIG. 8. As the voltage drops further, the current increases to the limiting level set by the error amplifier. At that point, the device has returned to its low resistance state, and current flows until the AC voltage drops to below the load voltage. The corresponding part of the ACB output current waveform is 812 on FIG. 8. When the next half cycle begins, the operation repeats.

When the output voltage exceeds the desired level, the error amplifier responds by changing the control signal in such a manner as to decrease Iₗᵢₘᵢₜ. Similarly, if the output voltage is too low, the error amplifier responds by changing the control signal so as to increase Iₗᵢₘᵢₜ. By controlling Iₗᵢₘᵢₜ during each cycle, the average current 814 over the AC cycle provided to the capacitor can be controlled and made equal to the average current supplied to the load.

FIG. 9 shows that changing Iₗᵢₘᵢₜ (e.g., from 906 to 908) can alter the average current (e.g., from 902 to 904).

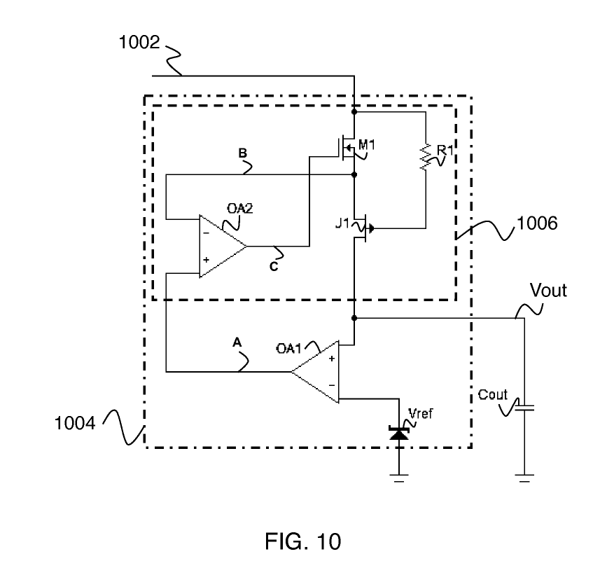

FIG. 10 shows an exemplary circuit implementation 1004. Here the circuitry shown in dotted box 1006 acts as ACB element 502 on FIG. 5. Here the ACB element includes first and second transistors (J1 and M1) connected in series to form a current path for the ACB current I_{ACB}. The gate of the first ACB transistor (J1) is connected to the input to the ACB element (via R1). The gate of the second ACB transistor (M1) is connected to an output of a linear differential amplifier (OA2) having as inputs a node between the first and second ACB transistors and the control signal (i.e., the output of OA1).

The operation of this circuit is as follows. M1 is a depletion mode N type MOSFET (NMOS) device and J1 is a P-type JPFET (PJFET). These devices are low resistance when the input rectified AC voltage 1002 is at zero. It is advantageous, though not a necessary requirement, to use depletion mode devices, as these require no bias to be initially conductive, and therefore allow the circuit to start up without any external biasing.

The linear error operational amplifier, OA1, provides an error voltage, V_{A}, at point A given by:

V_{A}=G₁*(V_{OUT}−V_{REF})

where:

G₁ is the error amplifier gain of amplifier OA1,

V_{OUT} is the output voltage, and

V_{REF} is the reference voltage.

The amplifier gain may be frequency dependent to provide the desired transient response characteristics, as is usual in analog control theory.

The linear operational amplifier, OA2 provides a voltage V_{C} at point C, such that:

V_{c}=G₂*(V_{A}−V_{B})

where:

G₂ is the error amplifier gain of amplifier OA2,

V_{A} is the error voltage at the output of OA1 (point A), and

V_{B} is the voltage developed at the source of J1 (point B).

As the rectified AC voltage 1002 rises above the output voltage, current flows in devices M1 and J1, causing a voltage drop across J1, thus increasing the voltage at B above the output voltage by I*R_{J1}, where R_{J1} is the JFET on-state resistance. When the rectified AC voltage causes sufficient current to flow, the voltage at B will exceed the voltage at the error amplifier output, A. This will cause the amplifier OA2 to lower its output voltage, reducing the voltage at the gate of M1. This closed loop feed back action causes M1 to limit the current to a level that maintains the voltage at B equal to that of amplifier output A. It can be seen that the higher the voltage is at A, the higher will be the level of the current limiting, and conversely, a low level, will cause a low level limit. Thus the function of a current limiting action dependent upon a control signal is realized.

As the rectified AC voltage rises, the gate voltage of J1 also rises through R1. Increasing gate voltage begins to pinch off J1. OA2 continues to operate to maintain the voltage at B approximately constant. As the output voltage is approximately constant, the voltage differential across the JFET remains approximately constant. Increasing resistance of J1 with increasing rectified AC voltage therefore causes the current to drop. Decreasing current with increasing voltage creates the negative resistance region of the ACB element.

As the rectified AC voltage increases further, the gate voltage of J1 becomes sufficient to pinch off the JFET. Amplifier OA2 continues to drive the NMOS gate to try to control the voltage at B, resulting in a gate drive to M1 that also acts to turn it off. Thus the device enters the third region of high resistance.

When the AC voltage has reached its peak, and the voltage returns towards zero at the end of the cycle, the JFET gate voltage eventually drops below the level required to hold it pinched off, which is at a similar voltage to that which caused the conduction to stop during the previous cycle. This is advantageous, as it creates a current waveform that has a characteristic double triangular shape (see FIGS. 8 and 9), thus giving a lower peak current than a single triangular wave shape having the same average current.

J1 begins to conduct again, and current begins to flow, increasing until the limiting value of current is once again achieved. Further decrease in rectified AC voltage causes the current to then drop back to zero. The cycle then repeats, with the amplifier OA1 modulating the voltage at A in response to the level of the output voltage, thus regulating the output.

A particularly advantageous feature of this design, being of regulated current limiting, is that even under short circuit conditions, the device will only supply the maximum current that it is designed for, and thus is inherently safe under short circuit conditions, as is usually required for power supplies in general.

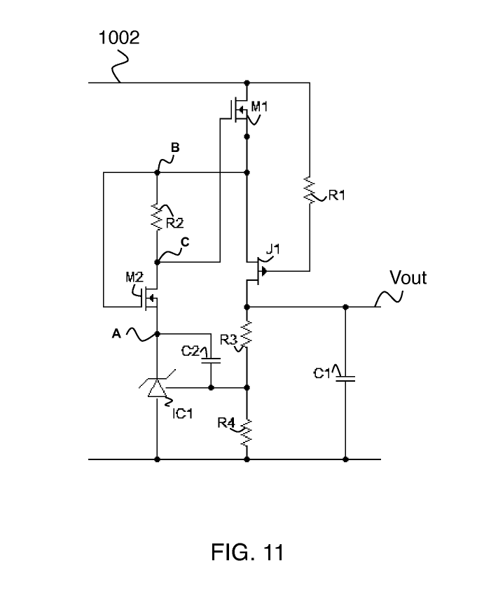

FIG. 11 shows another exemplary circuit implementation. A band gap reference Integrated Circuit, IC1, with functionality similar to an industry standard TLVH431 type reference, incorporates the function of both the voltage reference (Vref in FIG. 10) and the error amplifier, (OA1 in FIG. 10). This device provides an output voltage A that is proportional to the difference between the voltage at its gate terminal, and an internal reference of typically 1.25V. A simple single NMOS circuit including MOSFET M2 and resistor R2 provides the function of the amplifier OA2 in FIG. 10. Operation of this circuit is similar to the operation of the circuit of FIG. 10.

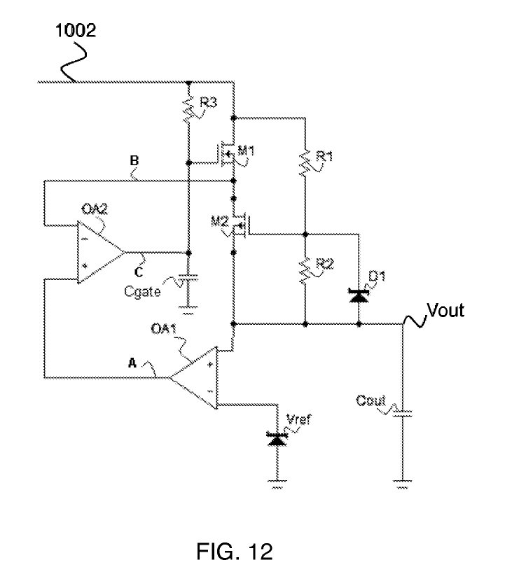

FIG. 12 shows a further exemplary circuit implementation. In this example, the same functionality as in earlier circuits may be created using enhancement mode MOSFET devices instead of depletion mode devices. Resistors R1 and R2 supply bias to M2, a PMOS type device. Avalanche device D1, or some other type of clamp, may be required to limit the maximum voltage to prevent against damage during transient conditions. Use of a JFET (as in FIG. 10) is advantageous because such biasing and clamping is not required, because the gate of a JFET inherently provides clamping functionality as in an avalanche diode.

Resistor R3 on FIG. 12 is used to provide gate drive to the NMOS device, M1, and capacitor Cgate retains bias voltage for the NMOS gate during the short periods when the rectified AC input voltage is lower than the NMOS gate voltage. Use of a depletion mode device (as in FIG. 10) may be advantageous, because resistor R3 of FIG. 12 must be capable of handling high voltage, and therefore undesirably takes up a lot of space in an IC implementation. Resistor R3 also adds to the power dissipation during the high resistance region of operation, thus decreasing overall efficiency.

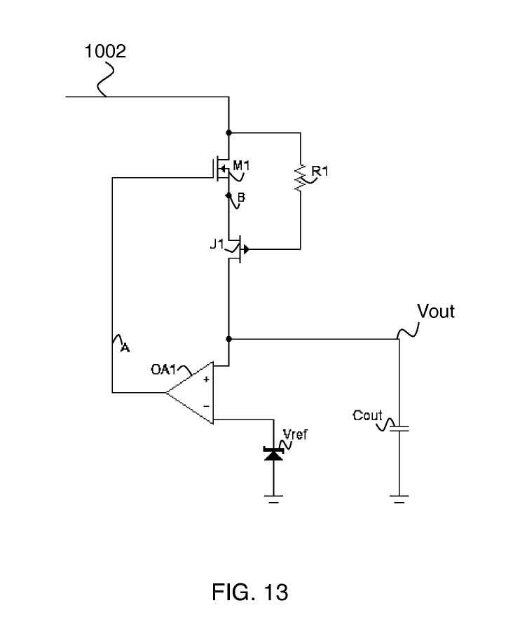

FIG. 13 shows a circuit that is similar to the example of FIG. 10. Here OA2 of FIG. 10 can be removed if there is enough gain provided by OA1. The gate of the first ACB transistor (J1) is connected to the input to the ACB element (via R1). The gate of the second ACB transistor (M1) is connected to the control signal (i.e., the output of OA1).

This simplified circuit works as follows. As the rectified AC voltage 1002 rises above the output voltage, current in devices M1 and J1 increases, causing a voltage drop across J1, thus increasing the voltage at B above the output voltage by I*RJ1, where RJ1 is the JFET on-state resistance. When the rectified AC voltage causes sufficient current to flow, the voltage at B will rise with respect to the steady state voltage at the error amplifier output, A. This will cause the MOSFET M1 Gate-Source voltage to drop below the level required to sustain the current level in M1, and hence will limit the current. It can be readily seen that the higher the voltage is at A, the higher will be the level of the current limiting, and conversely, a low level will cause a low level limit. Thus the function of a current limiting action dependent upon a control signal is realized.

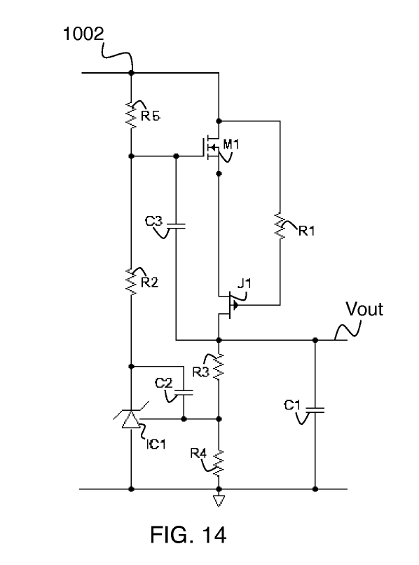

FIG. 14 shows a circuit that is similar to the circuit of FIG. 11 where the simplification of FIG. 13 is implemented. Here the resistor/capacitor network formed by R2/C3 is a practical consideration added to decouple the gate of M1, preventing undesirable effects due to Drain-Gate capacitance. Mixed type ACB circuits can also be implemented having an enhancement mode device and a depletion mode device. The circuit of FIG. 14 is an example of such a mixed type circuit, since J1 is depletion mode and M1 is enhancement mode.

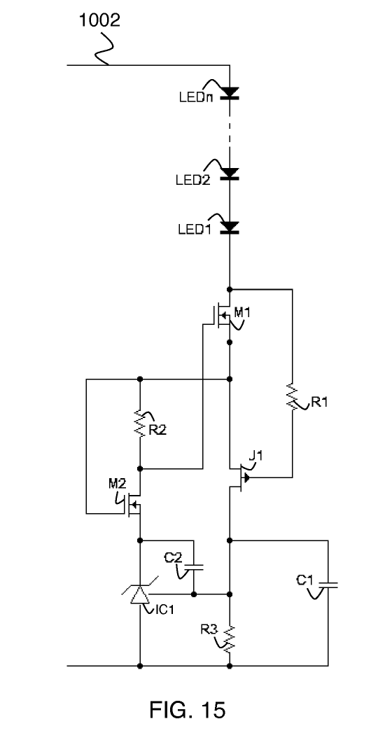

Since the power supply circuit of the present approach is essentially a closed loop controlled current source, it is possible to use the circuit directly to control current, as a constant current source, as is usually required for such devices as LEDs. FIG. 15 shows an exemplary circuit, where the circuit of FIG. 11 is adapted for use as a constant current source. In the circuit of FIG. 15, a low value resistor is used to sense the average current in R3.

R3 is chosen to set the current such that:

R₃=1.25/Iout

where
1.25V is the reference voltage level.
Iout is the required average current level Capacitor C1 is large enough to give a time constant of R3*C1 that is significantly longer than the rectified AC half cycle in order to provide a voltage across R3 that is proportional to the average output current. This circuit then maintains the required average current in the LEDs over a wide range of AC input voltages, number of LEDs, LED production variation and temperature of operation. Here the output of the power supply circuit is effectively a regulated current.

In summary, a simple power supply circuit is described that:
1) can efficiently provide a regulated voltage supply with intrinsic current limiting;
2) can efficiently provide a regulated constant current supply for driving devices such as LEDs;
3) is simple and easily integrated into a small footprint IC, giving a circuit that is much smaller, lower component count and lower cost than other solutions;
4) is easy to design with, requiring no special knowledge of high frequency switched mode power supplies;
5) does not cause high levels of electromagnetic interference, and thus requires neither special care in the implementation, nor large filtering components;
6) is inherently short circuit current limited; and
7) efficiently directly regulates the output to consume no more power than is needed by the load, and does not utilize wasteful shunt regulation or additional series regulation, as is used in other circuits.

### B) Power Supply Having Gain Stabilization

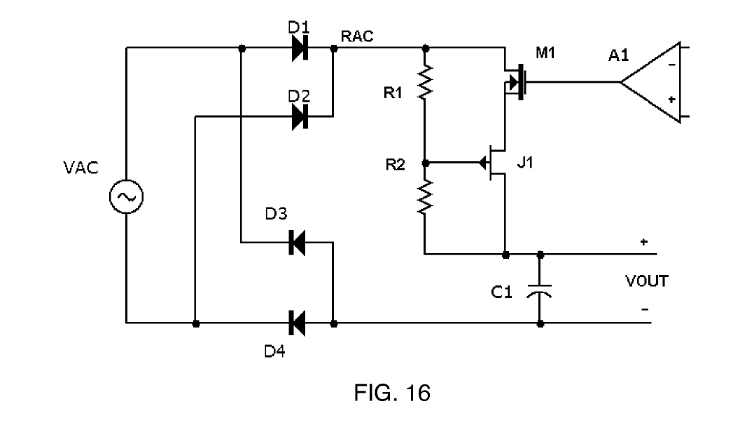

In some cases, it has been found useful to add gain stabilization to power supplies as described above. To better appreciate this idea, it is helpful to begin by considering operation of an exemplary practical circuit according to the above-described principles, as shown on FIG. 16.

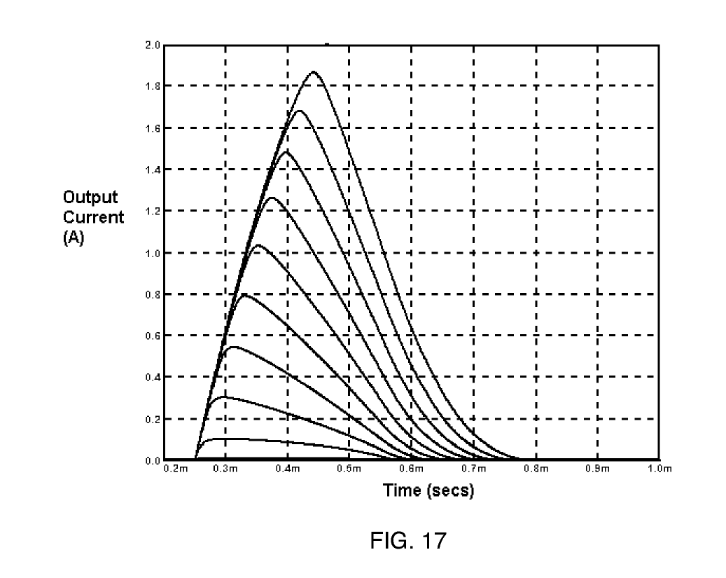

In this example, a P-type JFET, J1, is driven by a voltage derived from a potential divider, R1 and R2 fed by the same Rectified AC voltage (RAC), as is fed to the High Voltage NMOS power control device, M1. M1 is used in series with the JFET, with its gate driven by a control circuit, usually including an error amplifier, A1, which monitors the output voltage. The voltage at the source of the NMOS feeding the JFET is initially set by the ratio of the on-state resistances of M1 and J1, and the voltage difference between RAC and V_{OUT}. As the RAC voltage increases, the M1 source voltage eventually rises to the point that the gate-source voltage of M1 causes M1 to enter into constant current mode, causing the rising current to reach a maximum. The JFET gate voltage continues to rise with RAC, and rises to a voltage such that the JFET begins to pinch off, thus decreasing the current as RAC rises. The threshold at which this occurs depends upon the on-state resistances of J1 and M1 and the gate voltage of the NMOS, which is controlled in turn by the control voltage from amplifier A1. In this way, the peak current can be controlled in proportion to the control voltage. As the JFET gate voltage continues to rise, the JFET increases in resistance, and increasingly limits the current until it falls to zero. This results in an almost constant turn off period, regardless of peak current value, during which the circuit exhibits a negative resistance characteristic, that is, decreasing current with increasing applied voltage. A set of output current curves using incremental equal steps in NMOS gate voltage values is shown in FIG. 17, showing the typical dependence of the peak current on control voltage.

Maintaining accurate control of the voltage output of any closed loop feed back system requires an error amplifier with a carefully controlled gain characteristic in order to achieve best performance. An error voltage is generated by amplifying the difference between the output voltage and a precise reference voltage, and this voltage is used to control the peak current to achieve balance. In steady state operation, the regulation system adjusts the peak current in the waveform, such that the average current through the AC cycle exactly matches the average load current, thus maintaining the voltage constant.

As is typical in such closed loop systems, the open loop gain and frequency response must be carefully set for best response to sudden changes in load. Too much total open loop gain at higher frequencies will result in an under-damped response to transient loads resulting in overshoot, ringing and sometimes instability and oscillation. Too little gain will result in long settling times. As a result, large variations in the open loop gain of the system are undesirable, especially if the changes in gain result from differences in the AC input voltage, as this leads to differences in response in different markets around the world using different AC voltages.

The above-described basic power supply circuit using an LR, HR and negative resistance mode has a disadvantage in that a component of the gain varies inversely with the AC input voltage. The AC voltage rises almost linearly from zero volts, and the FET resistance is approximately constant, so the current initially rises roughly linearly with time, at a rate determined by the AC waveform, as seen in FIG. 17. When the required current peak is reached, the FET device is turned off over a period of time that in the example shown, is approximately constant regardless of peak current, although in alternative implementations the turn off time may differ.

In this case, the waveform having a sequence of triangular current pulses as shown in FIG. 17 has an average current given by

$${I}_{ave} = [ \frac{{I}_{p}^{2} * R}{4 * {V}_{p}} ] + [ 2 * {t}_{off} * f * {I}_{p} ]$$

where:
Iₐᵥₑ ave is the average current
Iₚ is the peak current value
R is the on state resistance of the FET
Vₚ is the AC peak voltage
t_{off} is the transition time between low and high resistance,
which is usually independent of the peak current, but inversely dependent upon the AC voltage
f is the AC mains frequency

As the peak current, Iₚ, is linearly proportional to the error voltage, Vₑᵣ then it can be seen then that the average current varies as a second order polynomial equation with the control voltage.

$${I}_{ave} = [ \frac{{( {k}_{1} * {V}_{er} )}^{2} * R}{4 * {V}_{p}} ] + [ 2 * \frac{{k}_{2}}{{V}_{p}} * f * ( {k}_{1} * {V}_{er} ) ]$$

where
k₁ is a constant relating Vₑᵣ to Iₚ
k₂ is a constant relating t_{off} to Iₚ
Vₑᵣ is the control voltage

As a result the transconductance of this circuit stage is given by:

$$\frac{d {I}_{ave}}{d {V}_{er}} = [ \frac{{k}_{1}^{2} * {V}_{er} * R}{2 * {V}_{p}} ] + [ 2 * \frac{{k}_{2}}{{V}_{p}} * f * {k}_{1} ) ]$$

That is, the transconductance, and therefore the overall gain of the circuit, will vary inversely with the AC voltage, V_{P}.

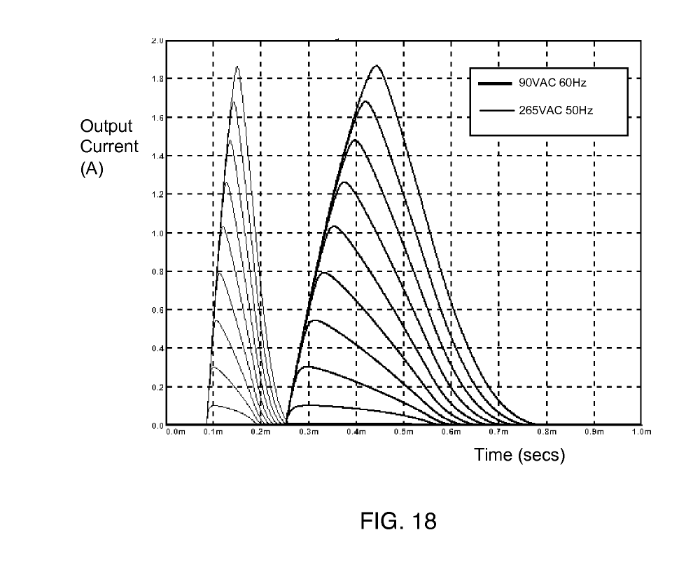

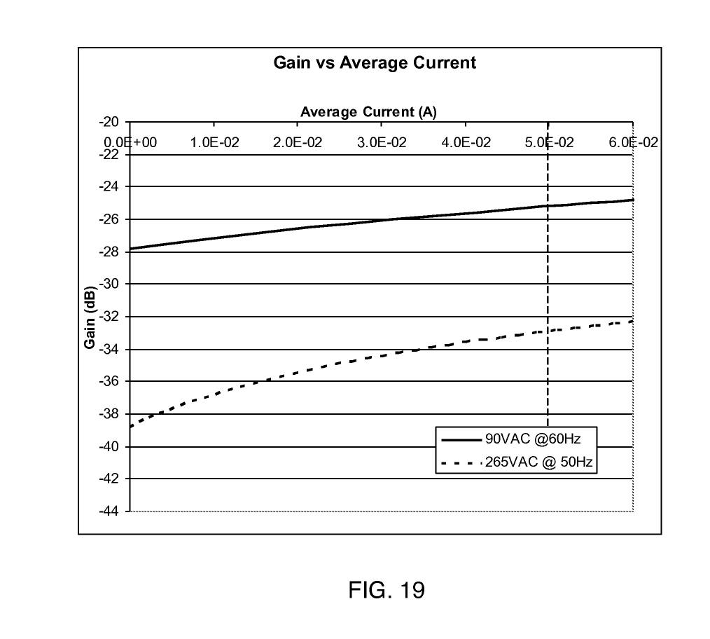

The cause of this can be seen by examining the same current waveforms that occur at higher AC input voltage. FIG. 18 shows the same set of curves as shown in FIG. 17, but with an additional set of curves with 265 VAC input voltage. In this case, the current rises and falls much more rapidly, and therefore the average current level of the waveform for a given control voltage is much lower at higher AC values.

The effect of this can be seen from a computation of the variation in gain with peak current, as shown in FIG. 19, comparing the gain at 90 VAC 60 Hz, with that at 265 VAC, 50 Hz, as is typical of the extremes of universal voltage operation.

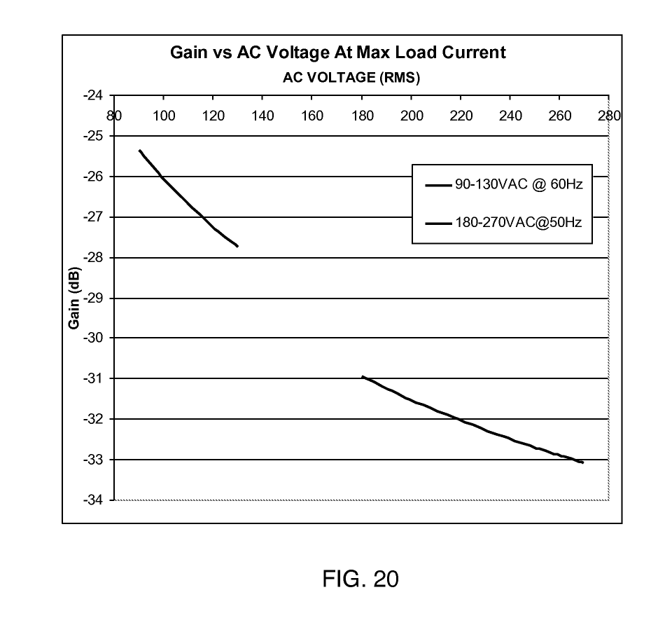

The variation in gain with input AC voltage at the maximum load current is seen in FIG. 20. It can be seen that there is almost 8 dB difference at the specified maximum operating average output current (50 mA in this case), which leads to significantly different output transient response at the extremes of input AC voltages.

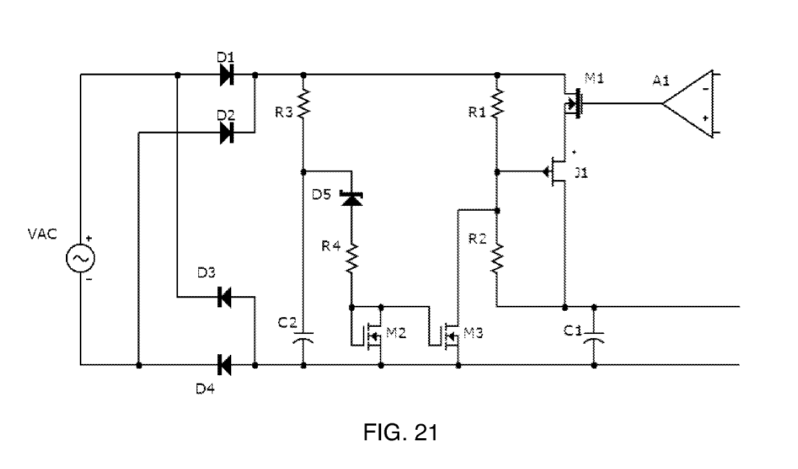

It is desirable to provide a circuit response that performs similarly to transient conditions over all operating input voltage ranges. The improved circuit in FIG. 21 achieves this function.

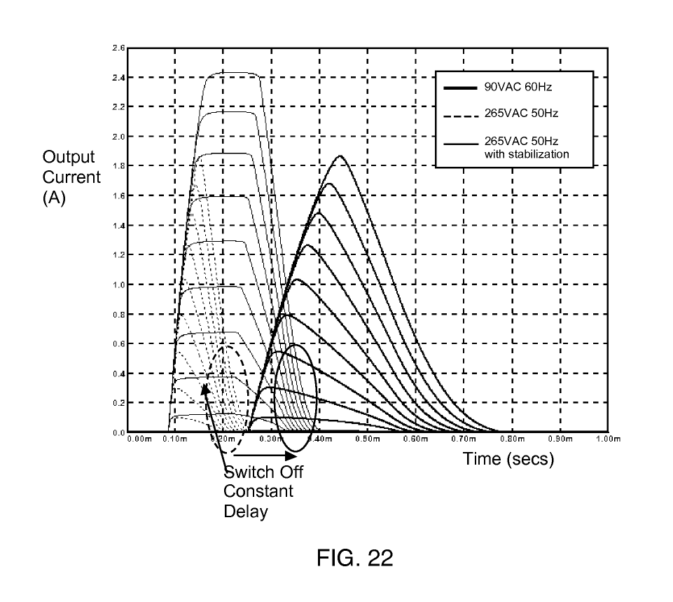

A circuit with stabilized gain is achieved by introducing a delay period at the current peak. The delay period is varied as a function of average AC input voltage to extend the total conduction period, thus allowing a higher average current with a lower peak current, as shown on FIG. 22. This amounts to providing a time delay between when Iₗᵢₘᵢₜ is reached and when the ACB element transitions toward the HR mode for at least some parameter values of the input AC voltage. This time delay can be a linear function of the voltage of the input AC voltage, and is preferably zero or negligible when the input AC voltage has a voltage at the low end of the designed operating range. In some embodiments, I_{ACB} is substantially constant between when Iₗᵢₘᵢₜ is reached and when the ACB element transitions toward the HR mode.

The delay at the peak current reduces to zero at the minimum required operating AC voltage, and so the effect of increasing the average current reduces proportionally. Conversely, the delay increases at higher AC voltages, resulting in a higher average output current than would otherwise result. An additional advantage is that the peak current at high voltage for the same average current is much less that the circuit without stabilization, allowing use of FET devices with lower saturation currents.

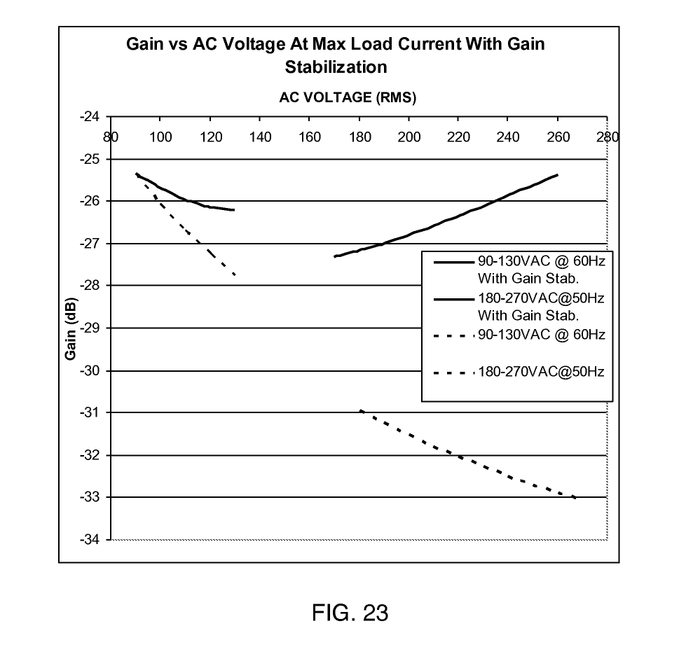

The gain can be stabilized such that at the maximum load point, where the transient response is most important, the gain remains within +/−1 dB over the range of operating input voltages, as seen in FIG. 23.

To perform this function a means of measuring the average input voltage is required, and a means of creating a delay in the waveform at the peak which is dependent upon the value of this voltage is also required. In the circuit in FIG. 21, resistors R3 and R4 and Avalanche or Zener diode D5 form a potential divider feeding a smoothing capacitor, C2, as an example of a means of providing a DC low voltage proportional to the average AC voltage. Zener diode D5 prevents current flowing into resistor R4 until the voltage across C2 exceeds the diode threshold voltage. The resistors and Zener diode are chosen in value such as to cause the onset of the compensation to occur at the desired input AC voltage, usually the minimum operating AC voltage. At that point, current flows through resistor R4 and is then fed into one side of a current mirror, in this case, using two N type MOSFET transistors M2 and M3. The current is mirrored by the second transistor, M3, with appropriate gain or attenuation, and then fed into the potential divider that drives the gate of the JFET.

At low AC voltages, no current flows in the mirror, and the JFET gate rises in proportion to the AC voltage, as in the basic circuit. At higher AC voltages, the current that the MOSFET M3 is trying to source is initially greater than the current flowing through the voltage divider, R1, feeding the JFET gate, and so the JFET gate remains pulled down to a low voltage, with the JFET turned fully on. After a period of time, the RAC voltage rises high enough such that the current in R3 exceeds the level of the current mirror, and then the gate of the JFET begins to rise, causing the JFET to turn off as before. As a result of this, a delay in JFET turn off is created that is a function of the AC input voltage.

This method has benefits in that the charged capacitor C2 can also be used as a low power supply to feed other circuits, and thus the additional complexity added to the basic circuit is very low. However, many alternative circuits designs could be used that would create a delay that is a function of the input AC voltage, or other parameters of concern in order to achieve appropriate compensation with that parameter, and consequently used to drive the output switching devices. In this case, the delay is a linear function of the AC voltage, but other higher order functions could be used.

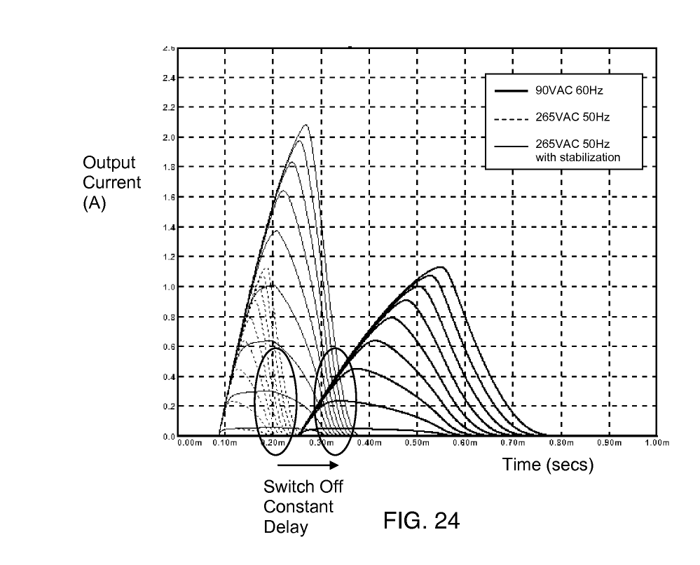

While the circuit described clearly shows a flat plateau at the maximum current of the pulse, adjustments in the device and circuit design parameters may lead to the shape of variable delay period not being flat, such as having a rounded feature, or some other shape or slope, as in FIG. 24.

The precise shape of the waveform during the delay period doesn't significantly alter the fundamental property of introducing a variable delay to increase the average current as a function of at least one other variable, and still leads to good stabilization of the gain over the operating range.

1. Apparatus comprising:
a rectifier circuit;
an integrating circuit;
an analog current blocking (ACB) element connected in series between the rectifier circuit and the integrating circuit, wherein the ACB element has two or more operating modes including a low-resistance (LR) mode and a high-resistance (HR) mode, and wherein the HR mode has a resistance sufficient to substantially block current flow through the ACB element;
wherein the ACB element automatically transitions toward the HR mode when a current through the ACB element (I_{ACB}) reaches a limit current Iₗᵢₘᵢₜ, and wherein the ACB element automatically transitions toward the LR mode when a voltage across the ACB element (V_{ACB}) goes below a reset voltage Vᵣₑₛₑₜ;
wherein the ACB element is configured such that Iₗᵢₘᵢₜ and Vᵣₑₛₑₜ are controlled by application of a control signal to the ACB element; and
a feed back control loop configured to hold an output of the integrating circuit constant at a predetermined value by varying the control signal when input AC power is provided to the rectifier circuit;
wherein the feed back control loop is configured to provide a time delay between when Iₗᵢₘᵢₜ is reached and when the ACB element transitions toward the HR mode, wherein the time delay is a function of a voltage of the input AC power.

2. The apparatus of claim 1, wherein the time delay is a linear function of the voltage of the input AC power.

3. The apparatus of claim 1, wherein I_{ACB} is substantially constant between when Iₗᵢₘᵢₜ is reached and when the ACB element transitions toward the HR mode.

4. The apparatus of claim 1, wherein the ACB element has a negative differential resistance (NDR) mode as an intermediate mode between the LR mode and the HR mode.

5. The apparatus of claim 4, wherein the NDR mode of the ACB element has an I/V slope of −1/R_{NEG}, wherein R_{NEG} is between about 0.2/Iₗᵢₘᵢₜₘₐₓ ohm and about 20/Iₗᵢₘᵢₜₘₐₓ ohm, where Iₗᵢₘᵢₜₘₐₓ is the maximum current limit of the apparatus.

6. The apparatus of claim 1, wherein the apparatus is configured to provide a regulated voltage.

7. The apparatus of claim 1, wherein the apparatus is configured to provide a regulated current.

8. The apparatus of claim 1, wherein the control signal is an output of a differential amplifier having as inputs a reference input and the output of the integrating circuit.

9. The apparatus of claim 1, wherein a resistance of the ACB element in the LR mode is less than about 50 ohms.

10. The apparatus of claim 1, wherein a resistance of the ACB element in the HR mode is greater than about 100 kohms.

11. A method for providing output DC power from input AC power, the method comprising:
rectifying the input AC power to provide a rectified signal;
providing the rectified signal as an input to an analog current blocking (ACB) element, wherein the ACB element has two or more operating modes including a low-resistance (LR) mode and a high-resistance (HR) mode, and wherein the HR mode has a resistance sufficient to substantially block current flow through the ACB element;
wherein the ACB element automatically transitions toward the HR mode when a current through the ACB element (I_{ACB}) reaches a limit current Iₗᵢₘᵢₜ, and wherein the ACB element automatically transitions toward the LR mode when a voltage across the ACB element (V_{ACB}) goes below a reset voltage Vᵣₑₛₑₜ;
wherein an output waveform of the ACB element is the rectified signal having some parts automatically blocked by the ACB element;
providing the output waveform of the ACB element as an input to an integrating circuit that provides an output DC signal;
wherein the ACB element is configured such that Iₗᵢₘᵢₜ and Vᵣₑₛₑₜ are controlled by application of a control signal to the ACB element; and
providing feedback control configured to hold the output DC signal constant at a predetermined value by varying the control signal;
wherein the feed back control is configured to provide a time delay between when Iₗᵢₘᵢₜ is reached and when the ACB element transitions toward the HR mode, wherein the time delay is a function of a voltage of the input AC power.

12. The method of claim 11, wherein the time delay is a linear function of the voltage of the input AC power.

13. The method of claim 11, wherein I_{ACB} is substantially constant between when Iₗᵢₘᵢₜ is reached and when the ACB element transitions toward the HR mode.

14. The method of claim 11, wherein the ACB element has a negative differential resistance (NDR) mode as an intermediate mode between the LR mode and the HR mode.

15. The method of claim 11, wherein a regulated voltage is provided to a load.

16. The method of claim 11, wherein a regulated current is provided to a load.
